(19) United States
(12) Patent Application Publication
(10) Pub. No.: US 2015/0077031 A1
(43) Pub. Date: Mar. 19, 2015

(54) NUMERICAL CONTROL DEVICE INCLUDING ROBOT CONTROLLER

(71) Applicant: FANUC CORPORATION, Yamanashi (JP)

(72) Inventors: Naoki Sugitani, Yamanashi (JP); Kazunari Aoyama, Yamanashi (JP)

(73) Assignee: FANUC CORPORATION, Yamanashi (JP)

(21) Appl. No.: 14/483,502

(22) Filed: Sep. 11, 2014

(30) Foreign Application Priority Data
Sep. 18, 2013 (JP) 2013-193029

(51) Int. Cl. G05B 19/414

(52) U.S. Cl. CPC G05B 19/414; G05B 2219/34441
USPC 318/600

(57) ABSTRACT

A numerical control device including a numerical controller, a robot controller, a servo control module and an I/O control module connected to the numerical controller and the robot controller, and an amplifier connecting bus connecting the servo control module and a servo amplifier, and an I/O device connecting bus connecting an I/O control module and an I/O interface device. The machine-tool-side and robot-side servo amplifiers are daisy-chained and the machine-tool-side and robot-side I/O interface devices are daisy-chained.

### BACKGROUND OF THE INVENTION

1. Field of the Invention

The present invention relates to a numerical control device controlling a robot together with a machine tool.

2. Description of the Related Art

Conventionally, devices that are intended to attach and detach a workpiece using a robot by combining a robot with an NC machine tool, devices described in Japanese Laid-open Patent Publication No. 4-155406 (JP4-155406A) and Japanese Laid-open Patent Publication No. 10-083211A (JP10-083211A) are known. This kind of device commonly includes a numerical control device controlling an NC machine tool and a robot controller controlling a robot. The numerical control device includes an amplifier connecting bus and an I/O device connecting bus to control, respectively, a servo amplifier and an I/O interface device of the machine tool side via these buses. The robot controller also includes an amplifier connecting bus and an I/O device connecting bus to control, respectively, a servo amplifier and an I/O interface device of the robot side via these buses.

In the conventional configuration described above, the numerical control device and the robot controller each include an amplifier connecting bus and an I/O device connecting bus. Therefore, there are many redundant portions in a circuit configuration, resulting in an increase in cost. Further, in order for both devices to transfer information and operate synchronously with each other, a separate communication unit is necessary, resulting in an increase in cost.

### SUMMARY OF THE INVENTION

A numerical control device of one aspect of the present invention includes a numerical controller controlling a machine tool, a robot controller controlling a robot, a servo control module connected to the numerical controller and the robot controller, and a bus connecting the servo control module and an external device, in which the external device includes a servo amplifier of a machine tool side and a servo amplifier of a robot side, and these servo amplifiers are daisy-chained to the servo control module via the bus.

A numerical control device of another aspect of the present invention includes a numerical controller controlling a machine tool, a robot controller controlling a robot, an I/O control module connected to the numerical controller and the robot controller, and a bus connecting the I/O control module and an external device, in which the external device includes an I/O interface device of a machine tool side and an I/O interface device of a robot side, and these I/O interface devices are daisy-chained to the I/O control module via the bus.

### BRIEF DESCRIPTION OF THE DRAWINGS

The objects, features, and advantages of the present invention will be clarified based on the embodiments described below in association with the accompanying drawings. In the accompanying drawings,

FIG. 1 is a block diagram illustrating a main configuration of a numerical control device according to an embodiment of the present invention; and

FIG. 2 is a diagram illustrating a comparative example of the embodiment of FIG. 1.

### DESCRIPTION OF THE EMBODIMENTS

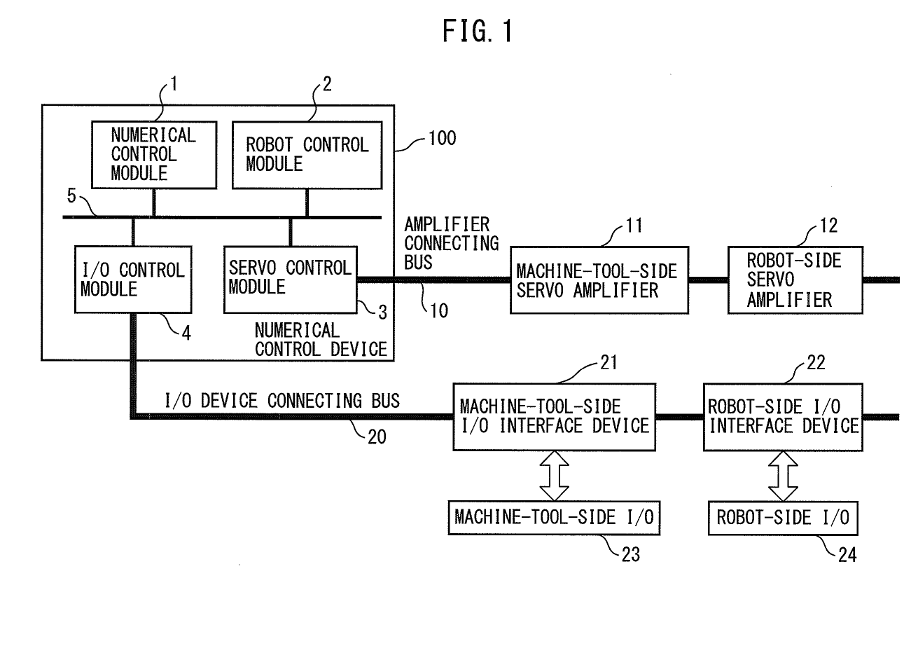

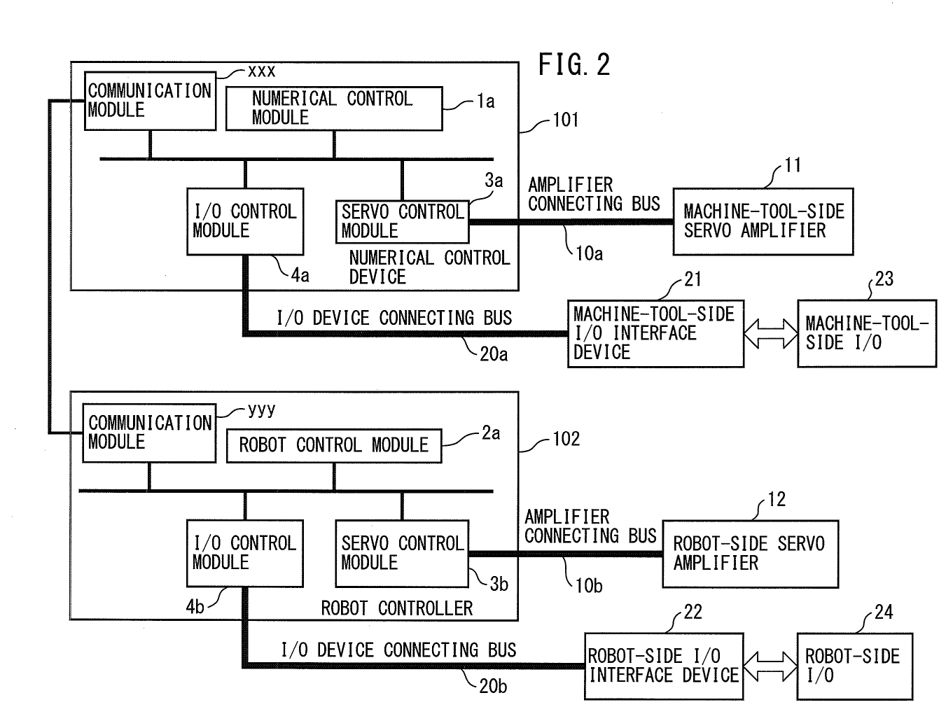

One embodiment of the numerical control device according to the present invention will now be described with reference to FIG. 1 and FIG. 2. FIG. 1 is a block diagram illustrating a main configuration of a numerical control device 100 according to the embodiment of the present invention. Although an illustration has been omitted, in the present embodiment, for example, an NC machine tool is combined with a robot and a workpiece is attached and detached using the robot. The numerical control device 100 includes a robot controller for controling the robot together with the machine tool.

As illustrated in FIG. 1, the numerical control device 100 includes a numerical control module 1 controlling a machine tool, a robot control module 2 controlling a robot, a servo control module 3 controlling a servo amplifier, and an I/O control module 4 controlling an I/O interface device. The numerical control module 1 and the robot control module 2 each are connected to the servo control module 3 and the I/O control module 4 via an internal local bus 5.

A servo amplifier 11 of a machine tool side and a servo amplifier 12 of a robot side are daisy-chained to the servo control module 3 via an amplifier connecting bus 10. In other words, the machine-tool-side servo amplifier 11 and the robot-side servo amplifier 12 are connected to the servo control module 3 in series (i.e., by being tied in a row).

In FIG. 1, the machine-tool-side servo amplifier 11 and the robot-side servo amplifier 12 are sequentially connected to the servo control module 3. However, the connection order of these servo amplifiers 11 and 12 may be reversed. A plurality of at least one of the machine-tool-side servo amplifier 11 and the robot-side servo amplifier 12 can be provided to daisy-chain a plurality of the servo amplifiers 11 and 12 via the amplifier connecting bus 10. In addition to the servo amplifiers 11 and 12, a spindle amplifier may be daisy-chained via the amplifier connecting bus 10. In other words, the configuration of external devices connected to the numerical control device 100 via the amplifier connecting bus 10 is not limited to the configuration of FIG. 1.

An I/O interface device 21 of the machine tool side and an I/O interface device 22 of the robot side are daisy-chained to the I/O control module 4 via the I/O device connecting bus 20. In other words, the machine-tool-side I/O interface device 21 and the robot-side I/O interface device 22 are connected to the I/O control module 4 in series (i.e., by being tied in a row). A machine-tool-side I/O 23 and a robot-side I/O 24 are connected to the machine-tool-side I/O interface device 21 and the robot-side I/O interface device 22, respectively. The machine-tool-side I/O 23 and the robot-side I/O 24 each include various types of switches, lamps, sensors, or the like.

In FIG. 1, the machine-tool-side I/O interface device 21 and the robot-side I/O interface device 22 are sequentially connected to the I/O control module 4. However, the connection order of these I/O interface devices 21 and 22 may be reversed. It is possible that a plurality of at least one of the machine-tool-side I/O interface device 21 and the robot-side I/O interface device 22 are provided to daisy-chain a plurality of the I/O interface devices 21 and 22 via the I/O device connecting bus 20. In other words, the configuration of external devices connected to the numerical control device 100 via the I/O device connecting bus 20 is not limited to the configuration of FIG. 1.

In the above-described configuration, the servo control module 3 serially transmits a control signal for the machine-tool-side servo amplifier 11 and a control signal for the robot-side servo amplifier 12 to the amplifier connecting bus 10, based on commands from the numerical control module 1 and the robot control module 2. This operation simultaneously controls a servo motor of the machine tool side and a servo motor of the robot side.

On the other hand, the I/O control module 4 executes a predetermined sequence program in response to input data received from the machine-tool-side I/O interface device 21 and the robot-side I/O interface device 22 via the I/O device connecting bus 20 and data of the numerical control module 1 and the robot control module 2; and then notifies the numerical control module 1 and the robot control module 2 of a processed result and also transmits output data to the machine-tool-side I/O interface device 21 and the robot-side I/O interface device 22 based on the processed result.

In this manner, according to the present embodiment, the numerical control device 100 includes the numerical control module 1 and the robot control module 2 to allow the numerical control device 100 to function as a robot controller. Further, the machine-tool-side servo amplifier 11 and the robot-side servo amplifier 12 are configured to be daisy-chained to the servo control module 3 via the amplifier connecting bus 10, and also the machine-tool-side I/O interface device 21 and the robot-side I/O interface device 22 are configured to be daisy-chained to the I/O control module 4 via the I/O device connecting bus 20.

This configuration allows an amplifier connecting bus for a machine tool and an amplifier connecting bus for a robot to be shared, and allows an I/O device connecting bus for the machine tool and an I/O device connecting bus for the robot to be shared in each case. As a result, it is enough to provide a single servo control module 3 and a single I/O control module 4 for the entire device, and therefore, the configuration of the entire device is simplified and then cost reduction can be realized. Further, information transfer between the numerical control module 1 and the robot control module 2 can be performed via the internal local bus 5, and therefore, a communication circuit (FIG. 2) is omissible, resulting in a possibility of cost reduction also from this point of view.

FIG. 2 is a diagram illustrating a comparative example in the present embodiment. In the figure, the same signs are assigned to the same parts as FIG. 1. In FIG. 2, in addition to a numerical control device 101, a robot controller 102 is separately provided. The numerical control device 101 includes a numerical control module 1a, a servo control module 3a, and an I/O control module 4a, and a robot controller 102 includes a robot control module 2a, a servo control module 3b, and an I/O control module 4b. The servo control module 3a of the numerical control device 101 is connected to the machine-tool-side servo amplifier 11 via an amplifier connecting bus 10a, and the I/O control module 4a is connected to the machine-tool-side I/O interface device 21 via an I/O device connecting bus 20a. The servo control module 3b of the robot controller 102 is connected to the robot-side servo amplifier 12 via an amplifier connecting bus 10b, and the I/O control module 4b is connected to the robot-side I/O interface device 22 via an I/O device connecting bus 20b.

In such a configuration of FIG. 2, the numerical control device 101 includes both the amplifier connecting bus 10a and the I/O device connecting bus 20a, and also the robot controller 102 includes both the amplifier connecting bus 10b and the I/O device connecting bus 20b. Therefore, the numerical control device 101 needs the servo control module 3a and the I/O control module 4a, and the robot controller 102 needs the servo control module 3b and the I/O control module 4b. Therefore, the number of components increases, resulting in an increase in cost. Further, in order for the numerical control device 101 and the robot controller 102 to operate synchronously with each other, communication units such as communication modules xxx and yyy are necessary, resulting in an increase in cost.

In the above-described embodiment (FIG. 1), the machine-tool-side and robot-side servo amplifiers 11 and 12 are configured to be daisy-chained via the amplifier connecting bus 10, and also the machine-tool-side and robot-side I/O interface devices 21 and 22 are configured to be daisy-chained via the I/O device connecting bus 20, but it is possible that only the servo amplifiers 11 and 12 or only the I/O interface devices 21 and 22 are daisy-chained. The numerical control module 1 as the numerical controller and the robot control module 2 as the robot controller provided for the numerical control device 100 may be configured in any manner.

According to the present invention, since the machine-tool-side servo amplifier and the robot-side servo amplifier, or the machine-tool-side I/O interface device and the robot-side I/O interface device are daisy-chained, the circuit configuration is simplified and therefore, the cost of the entire device can be reduced.

While the present invention has been described with reference to the preferred embodiments, it should be understood by those skilled in the art that various modifications and alterations may be made without departing from the disclosed scope of the claims to be described later.

1. A numerical control device comprising:
a numerical controller controlling a machine tool;
a robot controller controlling a robot;
a servo control module connected to the numerical controller and the robot controller; and
a bus connecting the servo control module and an external device, wherein
the external device includes a servo amplifier of a machine tool side and a servo amplifier of a robot side, and these servo amplifiers are daisy-chained to the servo control module via the bus.

2. A numerical control device comprising:
a numerical controller controlling a machine tool;
a robot controller controlling a robot;
an I/O control module connected to the numerical controller and the robot controller; and
a bus connecting the I/O control module and an external device, wherein
the external device includes an I/O interface device of a machine tool side and an I/O interface device of a robot side, and these I/O interface devices are daisy-chained to the I/O control module via the bus.
